(19) United States
(12) Patent Application Publication
(10) Pub. No.: US 2020/0146017 A1
(43) Pub. Date: May 7, 2020

(54) TECHNIQUES FOR ALLOCATING RESOURCES IN WIRELESS COMMUNICATIONS

(71) Applicant: QUALCOMM Incorporated, San Diego, CA (US)

(72) Inventors: Arjun BHARADWAJ, Cupertino, CA (US); Tien Viet NGUYEN, Bridgewater, NJ (US); Sudhir Kumar BAGHEL, Hillsborough, NJ (US); Kapil GULATI, Hillsborough, NJ (US); Shailesh PATIL, San Diego, CA (US)

(21) Appl. No.: 16/665,890

(22) Filed: Oct. 28, 2019

Related U.S. Application Data
(60) Provisional application No. 62/755,061, filed on Nov. 2, 2018.

(51) Int. Cl. H04W 72/04; H04W 74/08; H04L 5/00; H04L 1/00

(52) U.S. Cl. CPC H04W 72/0486; H04L 1/0003; H04L 5/0082; H04W 74/0808

(57) ABSTRACT

Aspects described herein relate to allocating resources in wireless communications were an allocation size of resource blocks (RBs) for transmitting a packet can be determined, and a sequence corresponding to the allocation size to use in transmitting a signal corresponding to the packet can be determined from a plurality of sequences corresponding to a plurality of allocation sizes. An available set of RBs corresponding to the allocation size can also be determined in a channel, and the signal can be transmitted over the available set of RBs and based on the sequence.

### CLAIM OF PRIORITY UNDER 35 U.S.C. § 119

The present application for patent claims priority to Provisional Application No. 62/755,061, entitled “TECHNIQUES FOR ALLOCATING RESOURCES IN WIRELESS COMMUNICATIONS” filed Nov. 2, 2018, which is assigned to the assignee hereof and hereby expressly incorporated by reference herein for all purposes.

### BACKGROUND

Aspects of the present disclosure relate generally to wireless communication systems, and more particularly, to allocating resources in wireless communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

Some wireless communication networks include vehicle-based communication devices that can communicate from vehicle-to-vehicle (V2V), vehicle-to-infrastructure (V2I) (e.g., from the vehicle-based communication device to road infrastructure nodes), vehicle-to-network (V2N) (e.g., from the vehicle-based communication device to one or more network nodes, such as a base station), a combination thereof and/or with other devices, which can be collectively referred to as vehicle-to-anything (V2X) communications. Without coordination/scheduling from the network for such communications, however, allocating resources for these types of communications may be challenging.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for wireless communication is provided. The method includes determining an allocation size of resource blocks (RBs) for transmitting a packet, determining, from a plurality of sequences corresponding to a plurality of allocation sizes, a sequence corresponding to the allocation size to use in transmitting a signal corresponding to the packet, determining, in a channel, an available set of RBs corresponding to the allocation size, and transmitting the signal over the available set of RBs and based on the sequence.

In another example, a method for wireless communication is provided. The method includes receiving multiple signals from multiple devices over a set of RBs, determining, based on a plurality of sequences corresponding to a plurality of allocation sizes, a sequence corresponding to each of the multiple signals, determining, based on the sequence, an allocation size of a set of the RBs corresponding to each of the multiple signals, and processing one or more of the multiple signals based on the allocation size.

In another example, an apparatus for wireless communication is provided. The apparatus includes a transceiver, a memory configured to store instructions, and one or more processors communicatively coupled with the transceiver and the memory. The one or more processors are configured to determine an allocation size of RBs for transmitting a packet, determine, from a plurality of sequences corresponding to a plurality of allocation sizes, a sequence corresponding to the allocation size to use in transmitting a signal corresponding to the packet determine, in a channel, an available set of RBs corresponding to the allocation size, and transmit the signal over the available set of RBs and based on the sequence.

In another example, an apparatus for wireless communication is provided. The apparatus includes a transceiver, a memory configured to store instructions, and one or more processors communicatively coupled with the transceiver and the memory. The one or more processors are configured to receive multiple signals from multiple devices over a set of RBs, determine, based on a plurality of sequences corresponding to a plurality of allocation sizes, a sequence corresponding to each of the multiple signals, determine, based on the sequence, an allocation size of a set of the RBs corresponding to each of the multiple signals, and process one or more of the multiple signals based on the allocation size.

In another example, an apparatus for wireless communication is provided. The apparatus includes means for determining an allocation size of RBs for transmitting a packet, means for determining, from a plurality of sequences corresponding to a plurality of allocation sizes, a sequence corresponding to the allocation size to use in transmitting a signal corresponding to the packet, means for determining, in a channel, an available set of RBs corresponding to the allocation size, and means for transmitting the signal over the available set of RBs and based on the sequence.

In another example, an apparatus for wireless communication is provided. The apparatus includes means for receiving multiple signals from multiple devices over a set of RBs, means for determining, based on a plurality of sequences corresponding to a plurality of allocation sizes, a sequence corresponding to each of the multiple signals, means for determining, based on the sequence, an allocation size of a set of the RBs corresponding to each of the multiple signals, and means for processing one or more of the multiple signals based on the allocation size.

In another example, a computer-readable medium, including code executable by one or more processors for wireless communications is provided. The code includes code for determining an allocation size of RBs for transmitting a packet, code for determining, from a plurality of sequences corresponding to a plurality of allocation sizes, a sequence corresponding to the allocation size to use in transmitting a signal corresponding to the packet, code for determining, in a channel, an available set of RBs corresponding to the allocation size, and code for transmitting the signal over the available set of RBs and based on the sequence.

In another example, a computer-readable medium, including code executable by one or more processors for wireless communications is provided. The code includes code for receiving multiple signals from multiple devices over a set of RBs, code for determining, based on a plurality of sequences corresponding to a plurality of allocation sizes, a sequence corresponding to each of the multiple signals, code for determining, based on the sequence, an allocation size of a set of the RBs corresponding to each of the multiple signals, and code for processing one or more of the multiple signals based on the allocation size.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a UE, in accordance with various aspects of the present disclosure;

FIG. 3 is a flow chart illustrating an example of a method for allocating resources in transmitting wireless communications, in accordance with various aspects of the present disclosure;

FIG. 4 is a flow chart illustrating an example of a method for processing wireless communications, in accordance with various aspects of the present disclosure;

FIG. 5 is an example of resource allocations for wireless communications, in accordance with various aspects of the present disclosure; and

FIG. 6 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to allocating resources for device-to-device (D2D) communication technologies. For example, D2D communication technologies can include vehicle-to-vehicle (V2V) communications, vehicle-to-infrastructure (V2I) communications (e.g., from a vehicle-based communication device to road infrastructure nodes), vehicle-to-network (V2N) communications (e.g., from a vehicle-based communication device to one or more network nodes, such as a base station), a combination thereof and/or with other devices, which can be collectively referred to as vehicle-to-anything (V2X) communications. In V2X communications, vehicle-based communication devices can communicate with one another and/or with infrastructure devices over a sidelink channel. Continued support and implementation of V2X communications is provided in fifth generation (5G) new radio (NR) communication technologies, as well as long term evolution (LTE). Though aspects are generally described herein in terms of V2X communications, the concepts and techniques can be similarly applied to more general D2D communications.

In V2X communications, devices can autonomously (e.g., without scheduling from a network entity) transmit communications to one another over a sidelink channel. This can be specifically true of V2X devices that are out of network coverage. In this example, such devices can attempt to acquire a channel over a set of resource blocks (RBs) for transmitting the communications (e.g., using a listen-before-talk (LBT) procedure). Aspects described herein relate to mitigating possible fragmentation of resources in selecting RBs over which to transmit V2X communications. For example, the frequency spectrum of the system band, or at least a channel of the system band, can be partitioned into granular resources for selecting such to minimize fragmentation and improve detection of V2X communications.

In particular, for example, V2X devices transmitting communications can select, based on the partitioning of the channel and a desired allocation size, a set of available RBs to use for transmitting the communications. For example, the channel may correspond to a portion of the system band, such that multiple channels may be defined over the system band. The V2X devices can apply a sequence, corresponding to the allocation size, to the communications for transmitting over the set of available RBs. A V2X device receiving the communications from one or more transmitting V2X devices can determine portions of the channel corresponding to the one or more transmitting V2X devices based on detecting sequences corresponding to one or more allocation sizes. For example, the receiving V2X device may determine a combination of one or more sequences yielding a highest signal energy for the channel, and may accordingly determine a partition of the channel for receiving one or more signals from the one or more transmitting V2X devices.

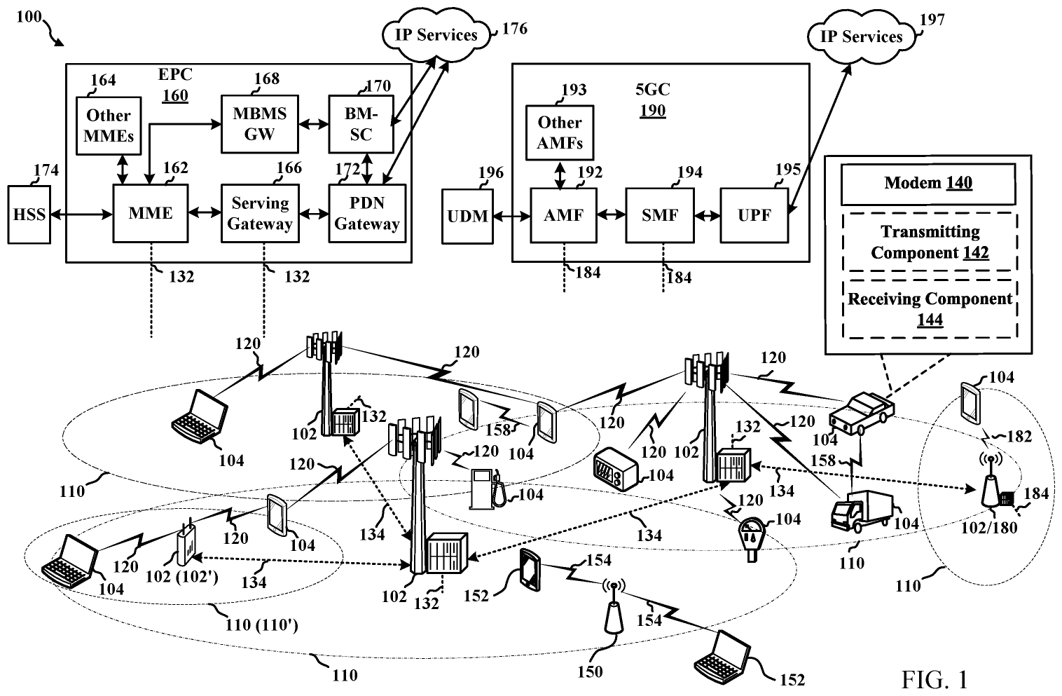

The described features will be presented in more detail below with reference to FIGS. 1-6.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, referring to the D2D communications described above, where the devices are vehicles or otherwise vehicle-based, the D2D communications between the devices (e.g., over a sidelink channel of communication link 158) can be referred to as V2V communications, which are defined for 3GPP LTE and are being defined for 5G NR. When the vehicles or vehicle-based devices communicate with other infrastructure nodes for the vehicle-based communications (e.g., over the sidelink), this can be referred to as V2I communications. When the vehicles or vehicle-based devices communicate with a base station 102 or other network node (e.g., over a communication link 120), this can be referred to as V2N communications. The collection of V2V, V2I, V2N, and/or vehicle-to-anything else can be referred to as V2X communications. In an example, LTE can support V2X communications (referred to as “LTE-V2X”) for safety messages communicated between vehicles and/or from vehicles to infrastructure. 5G NR can also support V2X (referred to as “NR-V2X”) for communications related to autonomous driving. For example, sidelink V2X communications may occur in a dedicated portion of spectrum such as the 5.9 GHz dedicated short range communications (DSRC) bandwidth reserved for vehicle communications.

In aspects described herein, UE 104 can include a modem 140 for communicating with other UEs and/or base stations in a wireless network. UE 104 can also include one or more of a transmitting component 142 for transmitting V2X (or more generally D2D) communications to one or more other UEs 104 and/or a receiving component 144 for receiving V2X (or more generally D2D) communications from one or more other UEs 104, as described further herein. In a specific example, the V2X communications can be transmitted and/or received over an allocation of multiple RBs. In LTE and/or 5G NR, for example, a frame structure may include a collection of frequency subcarriers defining a system band over a plurality of transmission time intervals (TTIs). A TTI may include one or more symbols (e.g., orthogonal frequency division multiplexing (OFDM) symbols), a slot of multiple symbols, a subframe of multiple slots, etc. The number of subcarriers and/or corresponding RBs (where an RB can include multiple subcarriers) can be defined based on a system bandwidth. For example, a 20 MHz band (or channel) may include 50 consecutive resource blocks, each including 12 subcarriers.

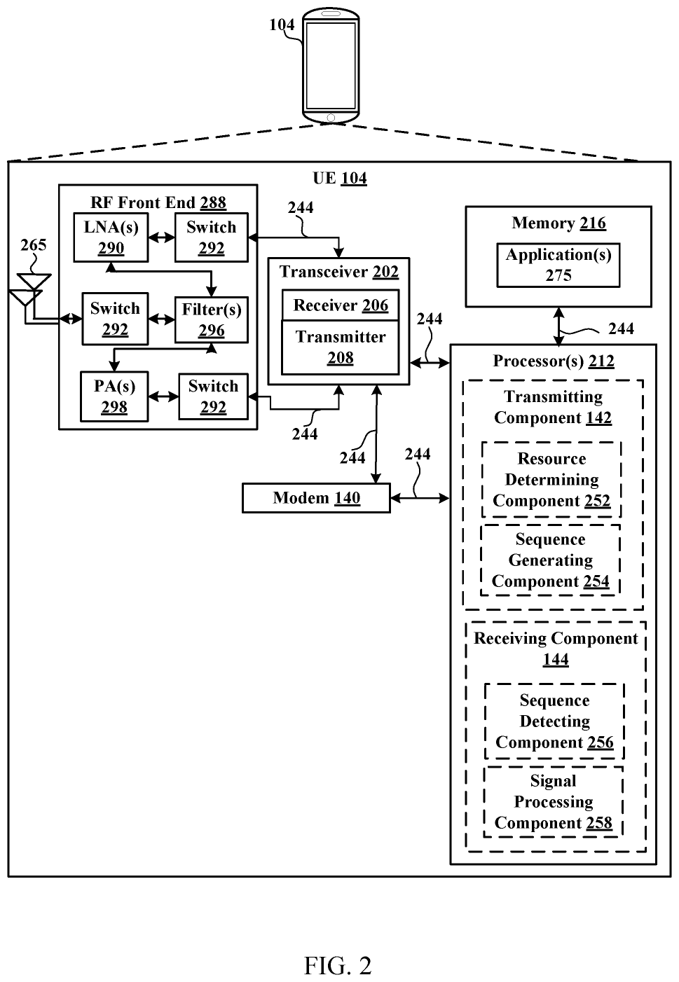

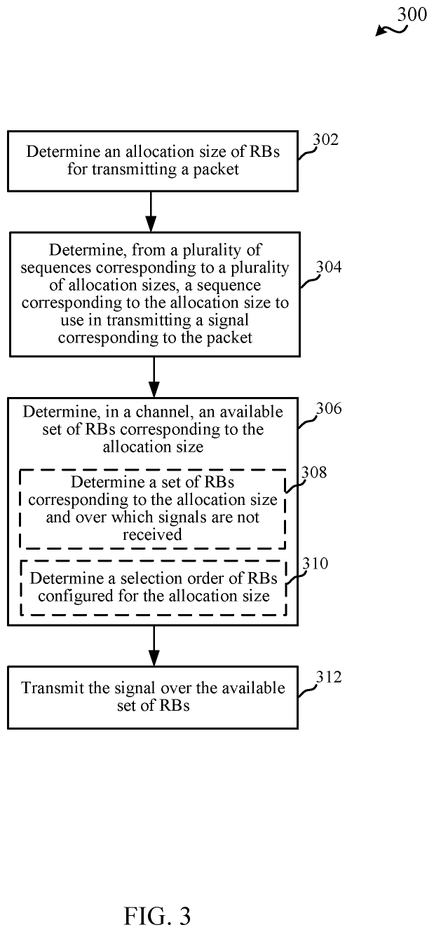

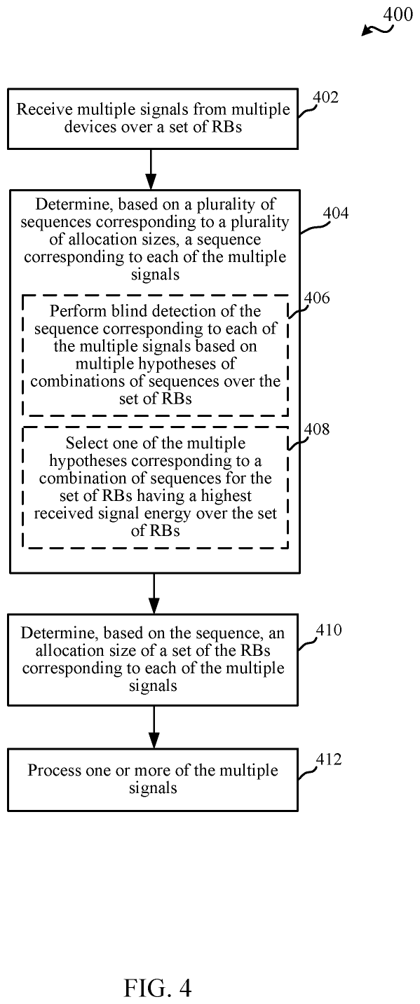

Turning now to FIGS. 2-6, aspects are depicted with reference to one or more components and one or more methods that may perform the actions or operations described herein, where aspects in dashed line may be optional. Although the operations described below in FIGS. 3-4 are presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 140, a transmitting component 142 for transmitting V2X (or more generally D2D) communications to one or more other UEs, and/or a receiving component 144 for receiving V2X (or more generally D2D) communications from one or more other UEs, according to one or more of the functions described herein.

In an aspect, the one or more processors 212 can include a modem 140 and/or can be part of the modem 140 that uses one or more modem processors. Thus, the various functions related to transmitting component 142 and/or receiving component 144 may be included in modem 140 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 140 associated with transmitting component 142 and/or receiving component 144 may be performed by transceiver 202.

Also, memory 216 may be configured to store data used herein and/or local versions of applications 275 or transmitting component 142 and/or receiving component 144 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining transmitting component 142 and/or receiving component 144 and/or one or more of its subcomponents, and/or data associated therewith, when UE 104 is operating at least one processor 212 to execute transmitting component 142 and/or receiving component 144 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 140 can configure transceiver 202 to operate at a specified frequency and power level based on the UE configuration of the UE 104 and the communication protocol used by modem 140.

In an aspect, modem 140 can be a multiband-multimode modem, which can process digital data and communicate with transceiver 202 such that the digital data is sent and received using transceiver 202. In an aspect, modem 140 can be multiband and be configured to support multiple frequency bands for a specific communications protocol. In an aspect, modem 140 can be multimode and be configured to support multiple operating networks and communications protocols. In an aspect, modem 140 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, transmitting component 142 can optionally include a resource determining component 252 for determining a set of RBs over which to transmit V2X communications, and/or a sequence generating component 254 for generating a sequence by which to transmit the V2X communications. In an aspect, receiving component 144 can optionally include a sequence detecting component 256 for detecting one or more sequences in a received set of RBs, and/or a signal processing component 258 for processing one or more signals in the received set of RBs based on the one or more detected sequences.

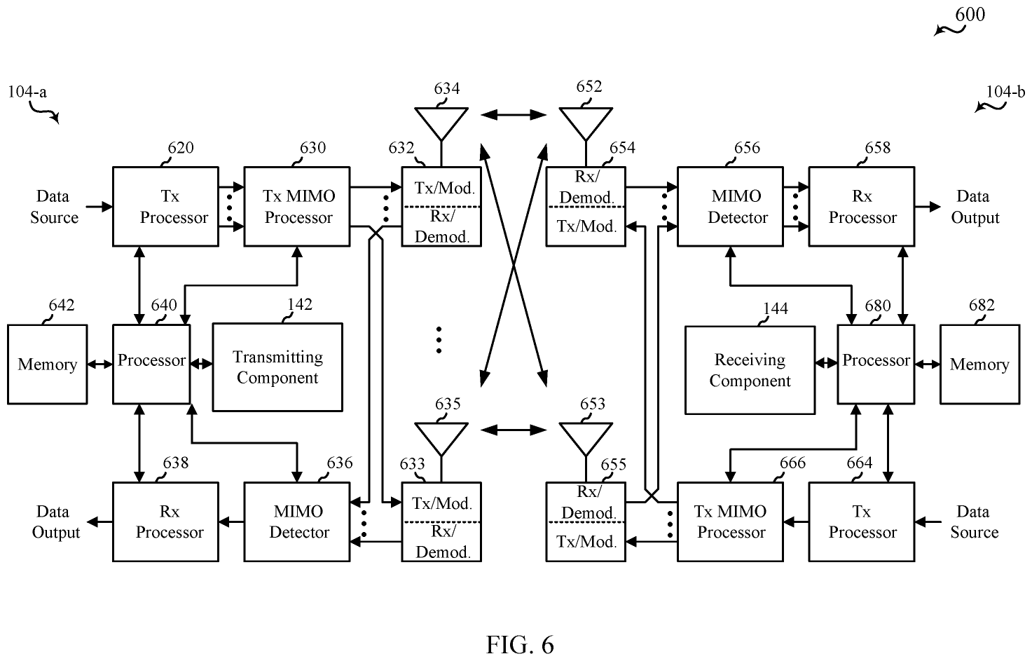

In an aspect, the processor(s) 212 may correspond to one or more of the processors described in connection with the UE in FIG. 6. Similarly, the memory 216 may correspond to the memory described in connection with the UE in FIG. 6.

FIG. 3 illustrates a flow chart of an example of a method 300 for determining resources over which to transmit communications. In an example, a UE 104 can perform the functions described in method 300 using one or more of the components described in FIGS. 1-2, such as transmitting component 142 and/or its subcomponents.

In method 300, at Block 302, an allocation size of RBs for transmitting a packet can be determined. In an aspect, resource determining component 252, e.g., in conjunction with processor(s) 212, memory 216, transceiver 202, transmitting component 142, etc., can determine an allocation size of RBs for transmitting a packet. For example, UE 104 can generate a packet for transmitting using V2X communications. In an example, the packet can be generating using one or more applications 275 specific to V2X communications and can be provided to lower layers for segmentation/transmitting over V2X communication resources. In one example, resource determining component 252 can determine an allocation size of RBs for transmitting the packet based on a packet size. In addition, in an example, resource determining component 252 can determine the allocation size based on a modulation scheme to use in transmitting the packet (e.g., quadrature phase shift keying (QPSK), 16-quadrature amplitude modulation (QAM), etc.), which may be configured based on detected channel conditions.

In one example, as described further herein, a channel can be divided into allocations of five RBs, with a minimum allocation size of 10 RBs. For example, the channel may correspond to a sidelink channel, which may be 20 MHz occupying 50 RBs. In one example, resource determining component 252 can determine the allocation size for transmitting the V2X communications as a number of RBs based on the determined packet size and/or modulation scheme (e.g., modulation and coding scheme (MCS)), which may be based on the table below or a similar table:

| | |
|---|---|
| QPSK | 16QAM |

| Packet Sizes [Bytes] | RBs | TTIs | RBs | TTIs |
|---|---|---|---|---|
| 200 | 20 | 1 | 10 | 1 |
| 400 | 15 | 2 | 15 | 1 |
| 600 | 20 | 2 | 20 | 1 |
| 800 | 25 | 2 | 25 | 1 |
| 1000 | 20 | 3 | 30 | 1 |
| 1200 | 25 | 3 | 15 | 2 |
| 1400 | 20 | 4 | 20 | 2 |
| 1600 | 25 | 4 | 25 | 2 |
| 1800 | 20 | 5 | 25 | 2 |
| 2000 | 25 | 5 | 25 | 2 |

In this example, based on the packet size and modulation scheme (e.g., QPSK or 16-QAM), resource determining component 262 can determine the allocation size as the number of corresponding RBs from the table and/or can determine the number of TTIs over which to transmit a corresponding signal in the number of RBs. For example, UE 104 can store this table and/or a similar table, or other information from which the allocation size of RBs can be determined, in memory 216. In another example, UE 104 can receive the table or other information in signaling from a base station 102, another UE 104, another network device, etc.

In method 300, at Block 304, a sequence corresponding to the allocation size to use in transmitting a signal corresponding to the packet can be determined from a plurality of sequences corresponding to a plurality of allocation sizes. In an aspect, sequence generating component 254, e.g., in conjunction with processor(s) 212, memory 216, transceiver 202, transmitting component 142, etc., can determine, from the plurality of sequences corresponding to the plurality of allocation sizes, the sequence corresponding to the allocation size to use in transmitting a signal corresponding to the packet. For example, sequence generating component 254 can obtain the plurality of sequences from a configuration stored in memory 216 of the UE 104, which may be configured in the memory 216, received from a base station 102, received from another UE 104, or received from another network component, etc., and may specify a sequence for each possible allocation size. In the example above, the plurality of sequences may include a different sequence for each allocation size of 10, 15, 20, 25, 30, 35, 40, 45, and/or 50 RBs. For example, the sequences may also be specific to the combination of allocation size and modulation scheme, or may be the specific to allocation size regardless of modulation scheme. In another example, the configuration may indicate instructions for computing the sequence based on (e.g., as a function of) the number of RBs.

For example, the sequence may refer to a code sequence to use in encoding a signal for transmission over a set of RBs, such as a Zadoff-Chu or similar sequence. In addition, the sequence may relate to a cyclic shift of a base sequence, such that a cyclic shift or cyclic-shifted base sequence may be configured for each possible resource allocation size. In any case, the transmitting component 142 can apply the sequence for transmitting signal, as described herein, to enable a receiving device to determine the resource allocation size (and/or modulation scheme) associated with the transmission, which can further enable determining a resource partitioning to process communications from multiple devices. This can be beneficial where multiple devices are attempting to communicate at the same or similar times, such as in V2X communications with many nearby communication devices transmitting over a sidelink channel.

In method 300, at Block 306, an available set of RBs corresponding to the allocation size can be determined in a channel. In an aspect, resource determining component 252, e.g., in conjunction with processor(s) 212, memory 216, transceiver 202, transmitting component 142, etc., can determine, in the channel, the available set of RBs corresponding to the allocation size. For example, resource determining component 252 can determine the available set of RBs as a subset of the channel. As described in one specific example, the channel may be partitioned into five RB allocations (e.g., a sub-channel size of 5 RBs), with a minimum allocation of 10 RBs. Thus, resource determining component 252 can determine a set of five RB allocations in available RBs of the channel to achieve the allocation size.

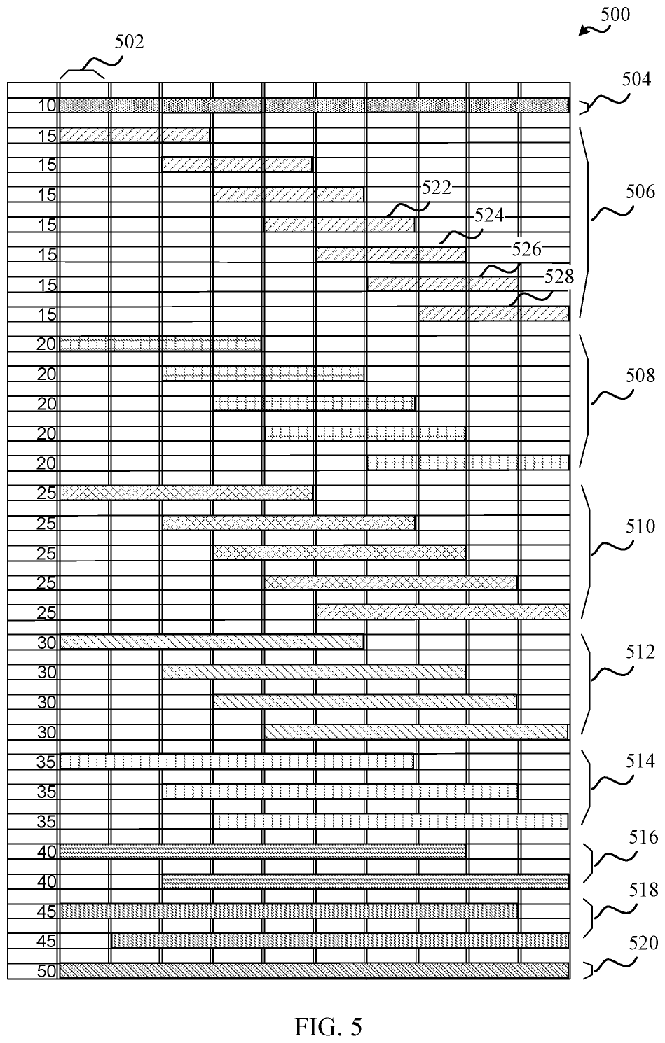

In one example, in determining the set of RBs at Block 306, optionally at Block 308, a set of RBs corresponding to the allocation size and over which signals are not received can be determined. In an aspect, resource determining component 252, e.g., in conjunction with processor(s) 212, memory 216, transceiver 202, transmitting component 142, etc., can determine the set of RBs corresponding to the allocation size and over which signals are not received. For example, the channel may or may not be at least partially occupied by one or more other devices transmitting communications. Thus, resource determining component 252 can listen for other transmissions in the channel and can accordingly determine an unoccupied set of RBs over which transmissions from other UEs are not detected in a time period. In one example, this can be part of performing a list-before-talk (LBT) or other clear channel assessment (CCA) process to determine whether the channel (or set of RBs) can be used for communications. In this example, resource determining component 252 can determine the available set of RBs within the unoccupied set of RBs as a subset of the unoccupied set of RBs corresponding to the allocation size. An example is shown in FIG. 5.

FIG. 5 illustrates examples of possible frequency resource allocations 500 for multiple allocation sizes. For example, in FIG. 5, the sub-channel size 502 is five RBs. Possible resource allocations for 10 RB channels are shown at 504. Possible resource allocations for 15 RB channels are shown at 506. Possible resource allocations for 20 RB channels are shown at 508. Possible resource allocations for 25 RB channels are shown at 510. Possible resource allocations for 30 RB channels are shown at 512. Possible resource allocations for 35 RB channels are shown at 514. Possible resource allocations for 40 RB channels are shown at 516. Possible resource allocations for 45 RB channels are shown at 518. A possible resource allocation for 50 RB channels is shown at 520.

Thus, in a specific example, where resource determining component 252 determines an allocation size of 15 RB for transmitting the packet, and detects received signals over the first 20 RBs, resource determining component 252 may determine the set of available RBs as the remaining 30 RBs, and thus the set of possible RB allocations as the set of allocations 522, 524, 526, or 528. In another example, where resource determining component 252 also detects signals received over the last 10 RBs, resource determining component 252 may determine the set of available RBs as the 20 RBs in between the first 20 RBs and the last 10 RBs, and thus the set of possible RB allocations as the set of allocations 522 or 524, etc. In addition, in this regard, resource determining component 252 may select the set of available RBs based on a desired selection order (e.g., a selection order for selection one of allocations 522, 524, 526, 528 in the example above for 15 RB allocation and where the first 20 RBs are considered occupied). In an example, resource determining component 252 can determine the desired selection order based on a configuration stored in memory 216 or otherwise received in a configuration from a base station 102, received from another UE, or received from another network component, etc., as described above. In other examples, the desired selection order may be determined based on a history of selection orders used by the UE 104 and/or corresponding communication results/desirability. In one example, the desired selection order can be defined per allocation size and/or per allocation size and detected occupied RBs.

Thus, for example, in determining the set of RBs at Block 306, optionally at Block 310, a selection order of RBs configured for the allocation size can be determined. In an aspect, resource determining component 252, e.g., in conjunction with processor(s) 212, memory 216, transceiver 202, transmitting component 142, etc., can determine the selection order of RBs configured for the allocation size. As described, the selection order can be configured and stored in memory 216 or otherwise received in a configuration from the base station 102, another UE 104, another network component, etc. In another example, resource determining component 252 can determine the selection order based on the detected occupied RBs. For example, where the first set of 20 RBs are occupied in the example above, a selection order may indicate sets 522 and 528 as preferred, such to leave a larger continuous set of unoccupied RBs for possible use by another device to transmit V2X communications. In any case, for example, resource determining component 252 can determine the selection order by determining at least one set of available RBs such that the remaining sets of RBs after selection leaves the most possible combinations of sets of RBs that could be occupied by other UEs wanting to perform channel access. Moreover, in an example, a set that leaves the larger continuous set of unoccupied RBs toward an end of the resource allocation may be preferred (e.g., prefer set 522 over set 528 to leave the unoccupied RBs toward the end of the resource allocation instead of in the middle). In this example, resource determining component 252 can select this set of RBs. This set of RBs can be determined by the resource determining component 252 based on detecting the unoccupied RBs. In another example, this set of RBs can be specified in a configuration related to possible combinations of unoccupied RBs, etc. In another example, resource determining component 252 can determine this set as a most desirable set and can determine other possible sets of RBs, and can select one of the sets of RBs based additionally on other considerations (e.g., as evaluated at different parts of the frequency spectrum corresponding to the RBs or otherwise), such as channel quality, metrics, detected interference, and/or the like.

In method 300, at Block 312, the signal can be transmitted over the available set of RBs. In an aspect, transmitting component 142, e.g., in conjunction with processor(s) 212, memory 216, transceiver 202, etc., can transmit the signal over the available set of RBs. For example, the resources can correspond to a sidelink channel, as described. In addition, for example, transmitting component 142 can transmit the signal, or another signal related to the signal (such as a LBT reservation sequence), based on or otherwise using the sequence. In one example, transmitting component 142 can transmit the signal along with other devices transmitting other signals over other sets of RBs in the channel. Using the specific sequence, in this regard, can allow a receiving device to determine a partitioning of the channel to differentiate multiple V2X communications transmitted by multiple devices over the channel, as described further herein.

FIG. 4 illustrates a flow chart of an example of a method 400 for processing one or more signals received from one or more devices in a channel. In an example, a UE 104 can perform the functions described in method 400 using one or more of the components described in FIGS. 1-2, such as receiving component 144 and/or its subcomponents.

In method 400, at Block 402, multiple signals can be received from multiple devices over a set of RBs. In an aspect, receiving component 144, e.g., in conjunction with processor(s) 212, memory 216, transceiver 202, etc., can receive the multiple signals from the multiple devices over the set of RBs. For example, the set of RBs may correspond to a portion of a channel, and may be partitioned to allow determination of subsets of the set of RBs that each include a communication from a separate device. As described, receiving component 144 may receive the communications over a sidelink or one or more sidelink channels defined in the channel or set of RBs.

In method 400, at Block 404, a sequence corresponding to each of the multiple signals can be determined based on a plurality of sequences corresponding to a plurality of allocation sizes. In an aspect, sequence detecting component 256, e.g., in conjunction with processor(s) 212, memory 216, transceiver 202, receiving component 144, etc., can determine, based on the plurality of sequences corresponding to the plurality of allocation sizes, the sequence corresponding to each of the multiple signals. For example, sequence detecting component 256 can attempt to detect a plurality of sequences transmitted in the channel, or at least a portion of the channel over which signal energy is detected.

In one example, in determining the sequence at Block 404, optionally at Block 406, blind detection of the sequence corresponding to each of the multiple signals can be performed based on multiple hypotheses of combinations of sequences over the set of RBs. In an aspect, sequence detecting component 256, e.g., in conjunction with processor(s) 212, memory 216, transceiver 202, receiving component 144, etc., can perform the blind detection of the sequence corresponding to each of the multiple signals based on the multiple hypotheses of combinations of sequences over the set of RBs. In one example, sequence detecting component 256 can test hypotheses corresponding to all possible combinations of sequences over the received set of RBs (e.g., all possible combinations of corresponding sequences of possible resource allocations using the allocations depicted in FIG. 5). In an example, sequence detecting component 256 can first determine a number of RBs that are occupied (e.g., over which signal energy is detected), and then can test hypotheses possible for the number of occupied RBs (e.g., according to one of various possible patterns for detection for at least the number and/or position within the resources of the occupied RBs).

Thus, in a specific example, sequence detecting component 256 can perform a blind detection using hypotheses that are based on all 10 RB allocations, a 10 RB allocation in the first 10 RBs and a 40 RB allocation in the next 40 RBs, a 10 RB allocation in the first 10 RBs and one or more different 35 RB allocations in the next 40 RBs, and so on, then on the next 10 RBa and a 30 RB allocation, etc., or on the first 15 RBs and a 35 RB allocation, etc. until all possible combinations are attempted. Thus, for example, sequence detecting component 256 may perform blind detection where at least two of the multiple hypotheses include sequences at the same starting RB of the set of RBs that correspond to different allocation sizes. In addition, for example, sequence detecting component 256 can perform blind detection based on hypotheses corresponding to more than two different signals in the RBs, etc. Performing blind detection, for example, can include attempting to decode the signals based on the corresponding sequences and determining which resulting decoding results in the highest received signal energy.

In addition, in this regard, possible combinations of resource allocations may be defined in a configuration, such to lessen the number of possible usable combinations and lower processing used to attempt blind detection over the possible usable combinations. In addition, in this example, the transmitting UE may be configured with the reduced set of possible usable combinations to use in determining an allocation size and sequence (e.g., as described in reference to Blocks 302 and 304 above).

In another example, in determining the sequence at Block 404, optionally at Block 408, one of the multiple hypotheses corresponding to a combination of sequences for the set of RBs having a highest received signal energy over the set of RBs can be selected. In an aspect, sequence detecting component 256, e.g., in conjunction with processor(s) 212, memory 216, transceiver 202, receiving component 144, etc., can select the one of the multiple hypotheses corresponding to the combination of sequences for the set of RBs having the highest received signal energy over the set of RBs. For example, sequence detecting component 256 can detect the combination of sequences as a partitioning of resources based on the received communications. The combination of sequences can be separated and identified to determine corresponding allocations sizes corresponding to the combination of sequences, and thus the partitioning of the channel into various sets of RBs corresponding to different communications based on the allocation sizes.

In method 400, at Block 410, an allocation size of a set of the RBs corresponding to each of the multiple signals can be determined. In an aspect, signal processing component 258, e.g., in conjunction with processor(s) 212, memory 216, transceiver 202, receiving component 144, etc., can determine, based on the sequence, the allocation size of the set of RBs corresponding to each of the multiple signals. As described, the sequence to use for each allocation size can be configured or otherwise stored in a configuration in memory 216. Thus, signal processing component 258 can determine the allocation size of communications in the channel based on the sequence, and can accordingly determine a partitioning of the channel used for the multiple signals based on applying the allocation size to a starting RB corresponding to each detected sequence.

In method 400, at Block 412, one or more of the signals can be processed. In an aspect, signal processing component 258, e.g., in conjunction with processor(s) 212, memory 216, transceiver 202, receiving component 144, etc., can process the one or more of the multiple signals. For example, signal processing component 258 can process the one or more of the multiple signals based on the determined allocation size, and can accordingly decode the one or more of the multiple signals to obtain the packet transmitted by the signal.

FIG. 6 is a block diagram of a MIMO communication system 600 including UEs 104-a, 104-b. The MIMO communication system 600 may illustrate aspects of the wireless communication access network 100 described with reference to FIG. 1. The UE 104-a may be an example of aspects of the UE 104 described with reference to FIGS. 1-2. The UE 104-a may be equipped with antennas 634 and 635, and the UE 104-b may be equipped with antennas 652 and 653. In the MIMO communication system 600, the UEs 104-a, 104-b may be able to send data over multiple communication links at the same time. Each communication link may be called a “layer” and the “rank” of the communication link may indicate the number of layers used for communication. For example, in a 2×2 MIMO communication system where UE 104-a transmits two “layers,” the rank of the communication link between the UE 104-a and the UE 104-b is two.

At the UE 104-a, a transmit (Tx) processor 620 may receive data from a data source. The transmit processor 620 may process the data. The transmit processor 620 may also generate control symbols or reference symbols. A transmit MIMO processor 630 may perform spatial processing (e.g., precoding) on data symbols, control symbols, or reference symbols, if applicable, and may provide output symbol streams to the transmit modulator/demodulators 632 and 633. Each modulator/demodulator 632 through 633 may process a respective output symbol stream (e.g., for OFDM, etc.) to obtain an output sample stream. Each modulator/demodulator 632 through 633 may further process (e.g., convert to analog, amplify, filter, and upconvert) the output sample stream to obtain a DL signal. In one example, DL signals from modulator/demodulators 632 and 633 may be transmitted via the antennas 634 and 635, respectively.

The UE 104-b may be an example of aspects of the UEs 104 described with reference to FIGS. 1-2. At the UE 104-b, the UE antennas 652 and 653 may receive the signals from the UE 104-a (e.g., over a sidelink) and may provide the received signals to the modulator/demodulators 654 and 655, respectively. Each modulator/demodulator 654 through 655 may condition (e.g., filter, amplify, downconvert, and digitize) a respective received signal to obtain input samples. Each modulator/demodulator 654 through 655 may further process the input samples (e.g., for OFDM, etc.) to obtain received symbols.

A MIMO detector 656 may obtain received symbols from the modulator/demodulators 654 and 655, perform MIMO detection on the received symbols, if applicable, and provide detected symbols. A receive (Rx) processor 658 may process (e.g., demodulate, deinterleave, and decode) the detected symbols, providing decoded data for the UE 104-b to a data output, and provide decoded control information to a processor 680, or memory 682.

The processor 680 may in some cases execute stored instructions to instantiate a receiving component 144 (see e.g., FIGS. 1 and 2).

At the UE 104-b, a transmit processor 664 may receive and process data from a data source. The transmit processor 664 may also generate reference symbols for a reference signal. The symbols from the transmit processor 664 may be precoded by a transmit MIMO processor 666 if applicable, further processed by the modulator/demodulators 654 and 655 (e.g., for SC-FDMA, etc.), and be transmitted to the UE 104-a in accordance with the communication parameters received from the UE 104-a. At the UE 104-a, the signals from the UE 104-b may be received by the antennas 634 and 635, processed by the modulator/demodulators 632 and 633, detected by a MIMO detector 636 if applicable, and further processed by a receive processor 638. The receive processor 638 may provide decoded data to a data output and to the processor 640 or memory 642.

The processor 640 may in some cases execute stored instructions to instantiate a transmitting component 142 (see e.g., FIGS. 1 and 2).

The components of the UEs 104-a, 104-b may, individually or collectively, be implemented with one or more ASICs adapted to perform some or all of the applicable functions in hardware. Each of the noted modules may be a means for performing one or more functions related to operation of the MIMO communication system 600. Similarly, the components of the UE 104-a may, individually or collectively, be implemented with one or more ASICs adapted to perform some or all of the applicable functions in hardware. Each of the noted components may be a means for performing one or more functions related to operation of the MIMO communication system 600.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method for wireless communication, comprising:

determining an allocation size of resource blocks (RBs) for transmitting a packet;

determining, from a plurality of sequences corresponding to a plurality of allocation sizes, a sequence corresponding to the allocation size to use in transmitting a signal corresponding to the packet;

determining, in a channel, an available set of RBs corresponding to the allocation size; and

transmitting the signal over the available set of RBs and based on the sequence.

2. The method of example 1, wherein determining the available set of RBs comprises:

receiving signals in the channel over one or more other sets of resources in a time period; and

detecting the available set of RBs as a portion of the channel over which signals are not received in the time period.

3. The method of example 2, wherein determining the available set of RBs further comprises transmitting a listen-before-talk (LBT) sequence in the available set of RBs.

4. The method of any of examples 1 to 3, wherein determining the available set of RBs is based at least in part on determining one of multiple sets of RBs that leave a largest number of contiguous sets of RBs available after selection.

5. The method of any of examples 1 to 4, wherein transmitting the signal comprises transmitting the signal in a same time period as a different device that transmits a different signal over another set of RBs and based on another sequence.

6. The method of any of examples 1 to 5, wherein determining the allocation size is further based on determining a modulation scheme to use in transmitting the packet.

7. The method of example 6, further comprising determining a number of transmission time intervals (TTIs) over which to transmit the packet, wherein transmitting the signal comprises transmitting the signal over the available set of RBs during the number of TTIs and according to the modulation scheme.

8. The method of any of examples 1 to 7, wherein transmitting the signal comprises transmitting the signal over a sidelink channel.

9. An apparatus for wireless communication, comprising:

a transceiver;

a memory configured to store instructions; and

one or more processors communicatively coupled with the transceiver and the memory, wherein the one or more processors are configured to:
determine an allocation size of resource blocks (RBs) for transmitting a packet;
determine, from a plurality of sequences corresponding to a plurality of allocation sizes, a sequence corresponding to the allocation size to use in transmitting a signal corresponding to the packet;
determine, in a channel, an available set of RBs corresponding to the allocation size; and
transmit the signal over the available set of RB s and based on the sequence.

10. The apparatus of example 9, wherein the one or more processors are configured to determine the available set of RBs at least in part by:

receiving signals in the channel over one or more other sets of resources in a time period; and

detecting the available set of RBs as a portion of the channel over which signals are not received in the time period.

11. The apparatus of example 10, wherein the one or more processors are configured to determine the available set of RBs at least in part by transmitting a listen-before-talk (LBT) sequence in the available set of RBs.

12. The apparatus of any of examples 9 to 11, wherein the one or more processors are configured to determine the available set of RBs based at least in part on determining one of multiple sets of RBs that leave a largest number of contiguous sets of RBs available after selection.

13. The apparatus of any of examples 9 to 12, wherein the one or more processors are configured to transmit the signal at least in part by transmitting the signal in a same time period as a different device that transmits a different signal over another set of RBs and based on another sequence.

14. The apparatus of any of examples 9 to 13, wherein the one or more processors are configured to determine the allocation size further based on determining a modulation scheme to use in transmitting the packet.

15. The apparatus of example 14, wherein the one or more processors are further configured to determine a number of transmission time intervals (TTIs) over which to transmit the packet, wherein the one or more processors are configured to transmit the signal over the available set of RBs during the number of TTIs and according to the modulation scheme.

16. The apparatus of any of examples 9 to 15, wherein the one or more processors are configured to transmit the signal over a sidelink channel.

17. An apparatus for wireless communication, comprising:

means for determining an allocation size of resource blocks (RBs) for transmitting a packet;

means for determining, from a plurality of sequences corresponding to a plurality of allocation sizes, a sequence corresponding to the allocation size to use in transmitting a signal corresponding to the packet;

means for determining, in a channel, an available set of RBs corresponding to the allocation size; and

means for transmitting the signal over the available set of RBs and based on the sequence.

18. The apparatus of example 17, wherein the means for determining the available set of RBs comprises:

means for receiving signals in the channel over one or more other sets of resources in a time period; and

means for detecting the available set of RBs as a portion of the channel over which signals are not received in the time period.

19. The apparatus of example 18, wherein means for determining the available set of RBs further comprises means for transmitting a listen-before-talk (LBT) sequence in the available set of RBs.

20. The apparatus of any of examples 17 to 19, wherein the means for determining the available set of RBs determines based at least in part on determining one of multiple sets of RBs that leave a largest number of contiguous sets of RBs available after selection.

21. The apparatus of any of examples 17 to 20, wherein the means for transmitting transmits the signal in a same time period as a different device that transmits a different signal over another set of RBs and based on another sequence.

22. The apparatus of any of examples 17 to 21, wherein means for determining the allocation size determines further based on determining a modulation scheme to use in transmitting the packet.

23. The apparatus of example 22, further comprising means for determining a number of transmission time intervals (TTIs) over which to transmit the packet, wherein the means for transmitting transmits the signal over the available set of RBs during the number of TTIs and according to the modulation scheme.

24. A computer-readable medium, comprising code executable by one or more processors for wireless communications, the code comprising:

code for determining an allocation size of resource blocks (RBs) for transmitting a packet;

code for determining, from a plurality of sequences corresponding to a plurality of allocation sizes, a sequence corresponding to the allocation size to use in transmitting a signal corresponding to the packet;

code for determining, in a channel, an available set of RBs corresponding to the allocation size; and

code for transmitting the signal over the available set of RBs and based on the sequence.

25. The computer-readable medium of example 24, wherein the code for determining the available set of RBs comprises:

code for receiving signals in the channel over one or more other sets of resources in a time period; and

code for detecting the available set of RBs as a portion of the channel over which signals are not received in the time period.

26. The computer-readable medium of example 25, wherein code for determining the available set of RBs further comprises code for transmitting a listen-before-talk (LBT) sequence in the available set of RBs.

27. The computer-readable medium of any of examples 24 to 26, wherein the code for determining the available set of RBs determines based at least in part on determining one of multiple sets of RBs that leave a largest number of contiguous sets of RBs available after selection.

28. The computer-readable medium of any of examples 24 to 27, wherein the code for transmitting transmits the signal in a same time period as a different device that transmits a different signal over another set of RBs and based on another sequence.

29. The computer-readable medium of any of examples 24 to 28, wherein code for determining the allocation size determines further based on determining a modulation scheme to use in transmitting the packet.

30. The computer-readable medium of example 29, further comprising code for determining a number of transmission time intervals (TTIs) over which to transmit the packet, wherein the code for transmitting transmits the signal over the available set of RBs during the number of TTIs and according to the modulation scheme.

What is claimed is:

1. A method for wireless communication, comprising:
determining an allocation size of resource blocks (RBs) for transmitting a packet;
determining, from a plurality of sequences corresponding to a plurality of allocation sizes, a sequence corresponding to the allocation size to use in transmitting a signal corresponding to the packet;
determining, in a channel, an available set of RBs corresponding to the allocation size; and
transmitting the signal over the available set of RBs and based on the sequence.

2. The method of claim 1, wherein determining the available set of RBs comprises:
receiving signals in the channel over one or more other sets of resources in a time period; and
detecting the available set of RBs as a portion of the channel over which signals are not received in the time period.

3. The method of claim 2, wherein determining the available set of RBs further comprises transmitting a listen-before-talk (LBT) sequence in the available set of RBs.

4. The method of claim 1, wherein determining the available set of RBs is based at least in part on determining one of multiple sets of RBs that leave a largest number of contiguous sets of RBs available after selection.

5. The method of claim 1, wherein transmitting the signal comprises transmitting the signal in a same time period as a different device that transmits a different signal over another set of RBs and based on another sequence.

6. The method of claim 1, wherein determining the allocation size is further based on determining a modulation scheme to use in transmitting the packet.

7. The method of claim 6, further comprising determining a number of transmission time intervals (TTIs) over which to transmit the packet, wherein transmitting the signal comprises transmitting the signal over the available set of RBs during the number of TTIs and according to the modulation scheme.

8. The method of claim 1, wherein transmitting the signal comprises transmitting the signal over a sidelink channel.

9. An apparatus for wireless communication, comprising:
a transceiver;
a memory configured to store instructions; and
one or more processors communicatively coupled with the transceiver and the memory, wherein the one or more processors are configured to:
determine an allocation size of resource blocks (RBs) for transmitting a packet;
determine, from a plurality of sequences corresponding to a plurality of allocation sizes, a sequence corresponding to the allocation size to use in transmitting a signal corresponding to the packet;
determine, in a channel, an available set of RBs corresponding to the allocation size; and
transmit the signal over the available set of RBs and based on the sequence.

10. The apparatus of claim 9, wherein the one or more processors are configured to determine the available set of RBs at least in part by:
receiving signals in the channel over one or more other sets of resources in a time period; and
detecting the available set of RBs as a portion of the channel over which signals are not received in the time period.

11. The apparatus of claim 10, wherein the one or more processors are configured to determine the available set of RBs at least in part by transmitting a listen-before-talk (LBT) sequence in the available set of RBs.

12. The apparatus of claim 9, wherein the one or more processors are configured to determine the available set of RBs based at least in part on determining one of multiple sets of RBs that leave a largest number of contiguous sets of RBs available after selection.

13. The apparatus of claim 9, wherein the one or more processors are configured to transmit the signal at least in part by transmitting the signal in a same time period as a different device that transmits a different signal over another set of RBs and based on another sequence.

14. The apparatus of claim 9, wherein the one or more processors are configured to determine the allocation size further based on determining a modulation scheme to use in transmitting the packet.

15. The apparatus of claim 14, wherein the one or more processors are further configured to determine a number of transmission time intervals (TTIs) over which to transmit the packet, wherein the one or more processors are configured to transmit the signal over the available set of RBs during the number of TTIs and according to the modulation scheme.

16. The apparatus of claim 9, wherein the one or more processors are configured to transmit the signal over a sidelink channel.

17. An apparatus for wireless communication, comprising:
means for determining an allocation size of resource blocks (RBs) for transmitting a packet;
means for determining, from a plurality of sequences corresponding to a plurality of allocation sizes, a sequence corresponding to the allocation size to use in transmitting a signal corresponding to the packet;
means for determining, in a channel, an available set of RBs corresponding to the allocation size; and
means for transmitting the signal over the available set of RBs and based on the sequence.

18. The apparatus of claim 17, wherein the means for determining the available set of RBs comprises:
means for receiving signals in the channel over one or more other sets of resources in a time period; and
means for detecting the available set of RBs as a portion of the channel over which signals are not received in the time period.

19. The apparatus of claim 18, wherein means for determining the available set of RBs further comprises means for transmitting a listen-before-talk (LBT) sequence in the available set of RBs.

20. The apparatus of claim 17, wherein the means for determining the available set of RBs determines based at least in part on determining one of multiple sets of RBs that leave a largest number of contiguous sets of RBs available after selection.

21. The apparatus of claim 17, wherein the means for transmitting transmits the signal in a same time period as a different device that transmits a different signal over another set of RBs and based on another sequence.

22. The apparatus of claim 17, wherein means for determining the allocation size determines further based on determining a modulation scheme to use in transmitting the packet.

23. The apparatus of claim 22, further comprising means for determining a number of transmission time intervals (TTIs) over which to transmit the packet, wherein the means for transmitting transmits the signal over the available set of RBs during the number of TTIs and according to the modulation scheme.

24. A computer-readable medium, comprising code executable by one or more processors for wireless communications, the code comprising:
code for determining an allocation size of resource blocks (RBs) for transmitting a packet;
code for determining, from a plurality of sequences corresponding to a plurality of allocation sizes, a sequence corresponding to the allocation size to use in transmitting a signal corresponding to the packet;
code for determining, in a channel, an available set of RBs corresponding to the allocation size; and
code for transmitting the signal over the available set of RBs and based on the sequence.

25. The computer-readable medium of claim 24, wherein the code for determining the available set of RBs comprises:
code for receiving signals in the channel over one or more other sets of resources in a time period; and
code for detecting the available set of RBs as a portion of the channel over which signals are not received in the time period.

26. The computer-readable medium of claim 25, wherein code for determining the available set of RBs further comprises code for transmitting a listen-before-talk (LBT) sequence in the available set of RBs.

27. The computer-readable medium of claim 24, wherein the code for determining the available set of RBs determines based at least in part on determining one of multiple sets of RBs that leave a largest number of contiguous sets of RBs available after selection.

28. The computer-readable medium of claim 24, wherein the code for transmitting transmits the signal in a same time period as a different device that transmits a different signal over another set of RBs and based on another sequence.

29. The computer-readable medium of claim 24, wherein code for determining the allocation size determines further based on determining a modulation scheme to use in transmitting the packet.

30. The computer-readable medium of claim 29, further comprising code for determining a number of transmission time intervals (TTIs) over which to transmit the packet, wherein the code for transmitting transmits the signal over the available set of RBs during the number of TTIs and according to the modulation scheme.
